(19) United States
(12) Patent Application Publication
(10) Pub. No.: US 2023/0409416 A1
(43) Pub. Date: Dec. 21, 2023

(54) INFORMATION SHARING SYSTEM, PROCESSING EXECUTION METHOD, AND INFORMATION STORAGE MEDIUM

(71) Applicant: Cybozu, Inc., Tokyo (JP)

(72) Inventors: Minoru KAWABATA, Tokyo (JP); Yuya KAWABATA, Nagareyama-shi (JP); Yuichi SUGIYAMA, Tokyo (JP); Shogo NINOMIYA, Ichikawa-shi (JP); Takahiro FUKUNISHI, Tokyo (JP); Takahiro YAMADA, Tokyo (JP); Kaoru NAKAJIMA, Tokyo (JP)

(21) Appl. No.: 18/139,962

(22) Filed: Apr. 27, 2023

(30) Foreign Application Priority Data
Apr. 28, 2022 (JP) 2022-074452

(51) Int. Cl. G06F 9/54; G06F 9/50

(52) U.S. Cl. CPC G06F 9/544; G06F 9/5005

(57) ABSTRACT

Provided is an information sharing system including at least one processor configured to: acquire a use status of use by each of a plurality of users for each of a plurality of functions relating to an information sharing service for sharing information; and execute, for each of the functions, predetermined processing relating to the function based on the use status of the function.

### CROSS-REFERENCE TO RELATED APPLICATION

The present disclosure contains subject matter related to that disclosed in Japanese Patent Application JP 2022-074452 filed in the Japan Patent Office on Apr. 28, 2022 the entire contents of which are hereby incorporated by reference.

### BACKGROUND OF THE INVENTION

### 1. Field of the Invention

The embodiments disclosed herein relate to an information sharing system, a processing execution method, and an information storage medium.

### 2. Description of the Related Art

Hitherto, there have been known information sharing services for sharing information among a plurality of users. For example, an information sharing service provides various functions including a schedule sharing function, a file sharing function, a database sharing function, and a communication function. When it is possible to acquire statuses of use by the users for each function provided by the information sharing service, it becomes easier to consider deleting or modifying each function, for example, and hence convenience of each user is expected to increase. It is conceivable that the use statuses of each function can be utilized for various other purposes.

For example, in Japanese Patent Application Laid-open No. 2012-174174, a technology for collecting use statuses such as a frequency of use and a usage time slot of each app installed on a user terminal is described. For example, in Japanese Patent Application Laid-open No. 2013-228820, a technology for acquiring information such as the launch time, end time, or launch location of an app as use statuses of each app installed on a user terminal and analyzing which app is frequently used is described.

However, in the technologies as described in Japanese Patent Application Laid-open No. 2012-174174 and Japanese Patent Application Laid-open No. 2013-228820, one app corresponds to one service, and hence the use statuses of an entire service are merely collected. In Japanese Patent Application Laid-open No. 2012-174174 and Japanese Patent Application Laid-open No. 2013-228820, there is no mention of collecting the use statuses of each of functions provided by one certain service. For that reason, even when the technologies as described in Japanese Patent Application Laid-open No. 2012-174174 and Japanese Patent Application Laid-open No. 2013-228820 are applied to an information sharing service, it is only possible to collect the use statuses of the entire information sharing service, and it is not possible to collect the use statuses of each of functions provided by the information sharing service.

### SUMMARY OF THE INVENTION

One object of the present disclosure is to improve convenience of each user in an information sharing service.

According to at least one aspect of the present disclosure, there is provided an information sharing system including at least one processor configured to: acquire a use status of use by each of a plurality of users for each of a plurality of functions relating to an information sharing service for sharing information; and execute, for each of the plurality of functions, predetermined processing relating to the each of the plurality of functions based on the use status of the each of the plurality of functions.

### BRIEF DESCRIPTION OF THE DRAWINGS

FIG. 1 is a diagram for illustrating an example of an overall configuration of an information sharing system.

FIG. 2 is a view for illustrating an example of a portal screen.

FIG. 3 is a diagram for illustrating functional blocks implemented by the information sharing system.

FIG. 4 is a table for showing an example of a user database.

FIG. 5 is a table for showing an example of a use status database.

FIG. 6 is a view for illustrating an example of a use status screen.

FIG. 7 is a flow chart for illustrating an example of processing to be executed by the information sharing system.

FIG. 8 is a diagram for illustrating functional blocks implemented in modification examples.

FIG. 9 is a view for illustrating an example of a use status screen in Modification Example 2.

FIG. 10 is a table for showing an example of an app database.

FIG. 11 is a view for illustrating an example of a portal screen in Modification Example 4.

### DESCRIPTION OF THE EMBODIMENTS

### 1. Overall Configuration of Information Sharing System

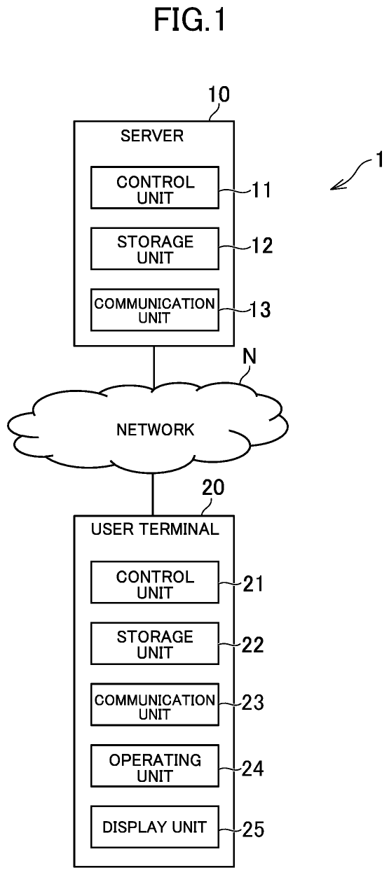

An example of an information sharing system according to at least one embodiment of the present disclosure is described. FIG. 1 is a diagram for illustrating an example of an overall configuration of the information sharing system. For example, an information sharing system 1 includes a server 10 and a user terminal 20. The server 10 and the user terminal 20 are each connected to a network N, such as the Internet or a LAN.

The server 10 is a server computer. A control unit 11 includes at least one processor. A storage unit 12 includes a volatile memory such as a RAM, and a non-volatile memory such as a flash memory. A communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. Hardware configurations of a control unit 21, a storage unit 22, and a communication unit 23 may be the same as those of the control unit 11, the storage unit 12, and the communication unit 13, respectively. An operating unit 24 is an input device, such as a mouse, a touch panel, or a keyboard. A display unit 25 is a liquid crystal display or an organic EL display.

Programs stored in the storage units 12 and 22 may be supplied through the network N. Hardware configurations of the server 10 and the user terminal 20 are not limited to the examples of FIG. 1. For example, a reading unit (for example, optical disc drive or memory card slot) for reading a computer-readable information storage medium or an input/output unit (for example, USB terminal) for directly connecting to an external device may be included. In this case, programs stored in the information storage medium may be supplied through intermediation of the reading unit or the input/output unit.

Further, it suffices that the information sharing system 1 includes at least one computer, and the information sharing system 1 is not limited to the example of FIG. 1. For example, a large number of users are present in actuality, and hence a large number of user terminals 20 may be included in the information sharing system 1. For example, the user terminal 20 may be present outside the information sharing system 1. In this case, the information sharing system 1 may include only the server 10 without including the user terminal 20. The information sharing system 1 may include the server 10 and a computer other than the user terminal 20.

### 2. Outline of Information Sharing System

The information sharing system 1 has a plurality of functions relating to an information sharing service for sharing information. Sharing information refers to providing information registered by a certain user to another user. Communicating among a plurality of users also corresponds to sharing information. Information to be shared may be of any type, for example, text, table, drawing, electronic mail, image data, document data, video data, audio data, or other data.

The function refers to an element of the information sharing system 1 available to the users. The function can be referred to as means or a tool for sharing information. The type of information to be shared differs depending on the function. In the information sharing system 1, information can be shared when various programs are executed, and hence an individual program or a set of code included in an individual program corresponds to the function.

For example, it is assumed that a user can use three functions A, B, and C of an information sharing service. In this case, a program PA for a function A, a program PB for a function B, and a program PC for a function C are present in the information sharing system 1. Thus, the programs PA, PB, and PC can also be said to be the functions A, B, and C, respectively, themselves. When the programs PA, PB, and PC are grouped into a single program, a set of code corresponding to the function A, a set of code corresponding to the function B, and a set of code corresponding to the function C are present in the single program. Those individual sets of code can also be said to be the functions A, B, and C, respectively, themselves.

The functions themselves provided by an information sharing service may be various known functions, for example, a schedule sharing function for sharing a schedule, a communication function for communicating through use of a chat, a web conference, or the like, and a file sharing function for sharing a file, and a database sharing function for sharing a database. In an information sharing service provided by a given business operator, a function may be provided through use of an app of another business operator different from the given business operator.

The at least one embodiment is described by taking, as an example, a case in which an information sharing service using cloud-type groupware is provided to users, but the information sharing service may be of any type, and is not limited to the example in the at least one embodiment. For example, the information sharing service may be a service using non-cloud-type on-premises groupware, or may be a cloud service of a type that is not called groupware.

For example, a user shares information within a group to which the user belongs. The group is a group of a plurality of users who share information. For example, an organization such as a company or a government office corresponds to the group. A department or a team within the organization also corresponds to the group. The user may share information with another user outside the group, or may share information with an indefinitely large number of other users without any particular concept of the group. For example, when the user operates the user terminal 20 to log in to an information sharing service, a portal screen of the information sharing service is displayed on the display unit 25.

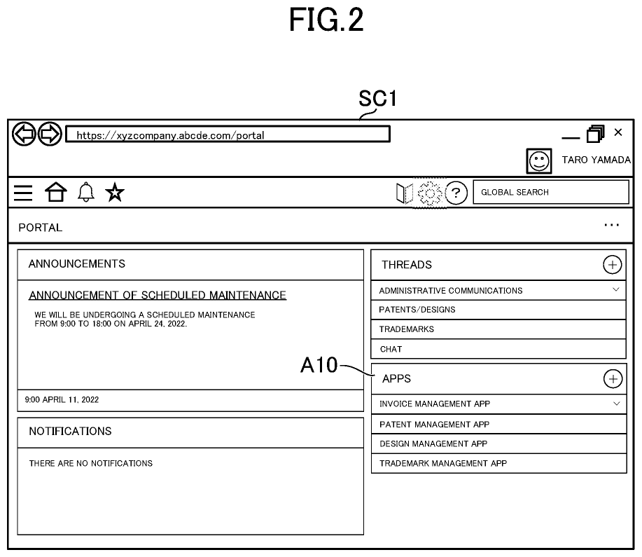

FIG. 2 is a view for illustrating an example of the portal screen. In the at least one embodiment, a case in which each screen is displayed on a browser of the user terminal 20 is described, but each screen may be displayed on a program (for example, so-called smartphone app) dedicated to an information sharing service which is installed on the user terminal 20. A portal screen SC1 corresponds to a top page of each individual group. A user can use various functions relating to the information sharing service from the portal screen SC1.

In the at least one embodiment, an app is described as an example of a function. Thus, the app as used herein can be read as “function.” The app is a tool for supporting the user's task. The app can also be considered as a task system tailored for the user's work. In the at least one embodiment, an app having the same function as that of spreadsheet software is taken as an example, but as the app itself, various known types of apps can be used. For example, the app may be an app having the same function as that of word-processing software, image editing software, or presentation software. Other functions such as a schedule management function may be provided as a type of app.

For example, a list of apps available to the user is displayed in a display area A10 of the portal screen SC1. The user can select and use any app from the display area A10. For example, when the user selects an app for “invoice management,” a table including various kinds of information such as an invoice management number, a date, an amount, and a person in charge is displayed on the display unit 25. For example, when the user selects an app for “patent management,” a table including various kinds of information such as an application number, a filing date, and a current status of a patent application is displayed on the display unit 25.

For example, the app may include not only records that form a table but also other information such as comments input by the user, reactions of the user to comments input by other users, and files uploaded by the user. Thus, the app has not only a database function equivalent to that of spreadsheet software but also other functions such as a communication function in combination. The user may use an app provided in advance by the information sharing service or may create and add an app by himself or herself.

There are various apps in the information sharing system 1, and hence some apps are frequently used, while some apps are rarely used. In addition, some apps were frequently used before but are no longer frequently used recently. In contrast, some apps were not frequently used before but are frequently used recently. For those reasons, when it is possible to acquire a use status of each individual app, it becomes easier for an administrative user who has administrative authority to consider, for example, deleting or modifying the app, and hence convenience of the user is expected to increase. This point also applies to functions other than apps.

In view of this, the information sharing system 1 in the at least one embodiment acquires a status of use by the user for each app. For example, the information sharing system 1 displays the use status of each app on the user terminal 20 of the administrative user. Thus, it becomes easier for the administrative user to examine the use status of each app and consider various operations such as deleting or modifying each app, thereby increasing convenience. Details of the information sharing system 1 are described below.

### 3. Functions Implemented by Information Sharing System

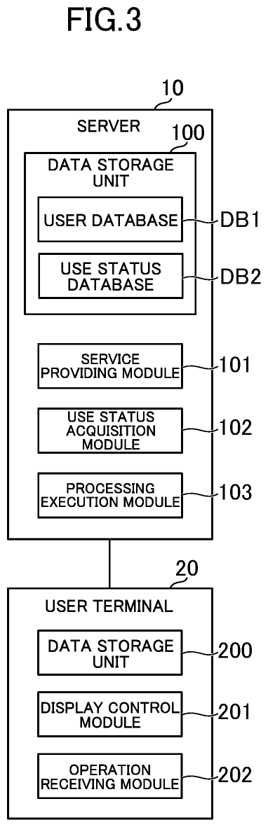

FIG. 3 is a diagram for illustrating functional blocks implemented by the information sharing system 1.

### 3-1. Functions Implemented by Server

A data storage unit 100 is implemented by the storage unit 12. A service providing module 101, a use status acquisition module 102, and a processing execution module 103 are implemented by the control unit 11.

[Data Storage Unit]

The data storage unit 100 stores data required for providing an information sharing service to a user. In the at least one embodiment, a user database DB1 and a use status database DB2 are described as examples of the stored data.

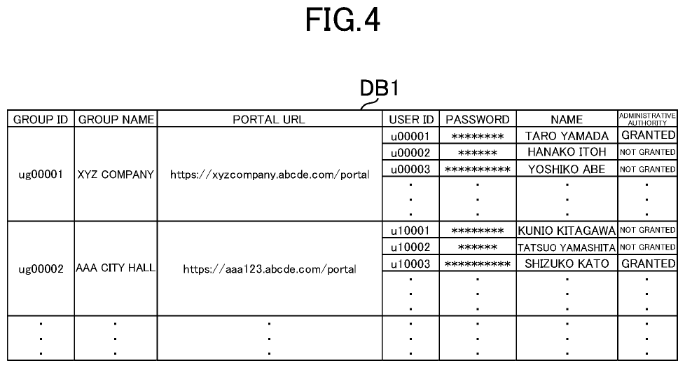

FIG. 4 is a table for showing an example of the user database DB1. The user database DB1 is a database in which various kinds of information relating to users are stored. For example, the user database DB1 stores a group ID, a group name, a portal URL, a user ID, a password, a full name, and presence or absence of administrative authority. Under the group ID of a certain group, the user database DB1 stores the user ID, password, full name, and presence or absence of administrative authority of a user belonging to the certain group together with a URL of a portal of the certain group.

In the at least one embodiment, the plurality of users include an administrative user who has administrative authority and a general user who has no administrative authority. The administrative authority stored in the user database DB1 is information indicating whether or not the user is an administrative user. In the at least one embodiment, the administrative authority for an entire group is taken as an example, but the administrative user is not limited to the example of the at least one embodiment as long as the administrative user is a user who has some administrative authority. For example, the administrative user may be a user who manages an individual function, which is exemplified by an app, instead of a group.

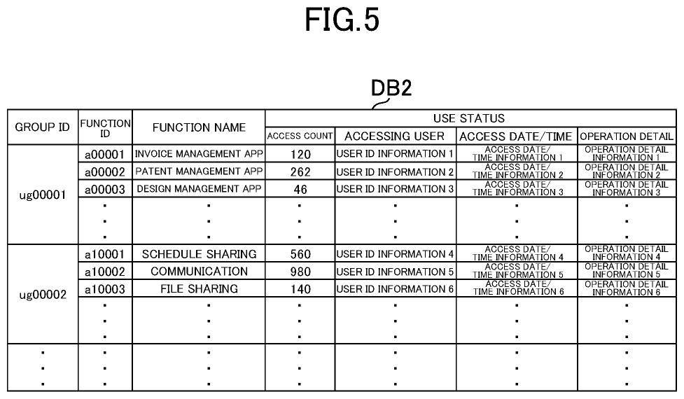

FIG. 5 is a table for showing an example of the use status database DB2. The use status database DB2 is a database in which the use statuses of functions are stored. For example, the use status database DB2 stores a group ID, a function ID, a name of the function, and use statuses of the function. In the example of FIG. 5, the use statuses of functions (for example, schedule sharing function) other than apps are also shown, but a separate use status database DB2 may be provided for each function. In the at least one embodiment, the use statuses of apps are mainly described.

The use status is information indicating to what extent or how the function, which is exemplified by the app, has been used. In the example of FIG. 5, as the use statuses, the number of times of access, the user ID of a user who has had access, an access date and time, and a specific operation detail of the user (for example, whether the user has only viewed information, has performed an operation for updating or deleting information, or the like) are shown. In the at least one embodiment, the number of times of access is mainly described. Thus, the number of times of access as used herein can be read as “use status.” The number of times of access can also be said to be the number of times of use or the number of times of display of a function, which is exemplified by an app.

The use status is not limited to the example of the at least one embodiment as long as the use status is information that can be acquired by the server 10 based on information received from the user terminal 20. For example, the use status may be information such as the number of times of updating information (for example, record of an app), the number of comments, the number of replies to comments, the number of reactions to comments, the type of user terminal 20 (for example, personal computer, smartphone, or tablet terminal), access location (for example, position of the user terminal 20), or a display time period as described later in Modification Example 8.

Further, the use status database DB2 may store the use statuses for the entire past period, or may store only the use statuses for the most recent part of the period. In the example of FIG. 5, a case in which the status of use by the entire group (for example, number of times of access in the entire group) for a certain function is stored in the use status database DB2 is shown, but the individual status of use by each individual user may be stored in the use status database DB2. For example, the number of times of access that a certain user X has accessed an invoice management app and the number of times of access that another user Y has accessed the invoice management app may be stored as separate use statuses in the use status database DB2.

Further, data stored in the data storage unit 100 is not limited to the above-mentioned examples. For example, the data storage unit 100 may store a database in which information (actual data of information to be shared) registered in each function, which is exemplified by an app, is stored. The information stored in this database is shared by a plurality of users. For example, the data storage unit 100 may store an API for providing each function to each user. In this case, the API for a certain function provides the certain function to the user by transmitting, to the user terminal 20, a processing result corresponding to a request received from the user terminal 20. When an API is provided for each function, the API can be said to be the function itself.

[Service Providing Module]

The service providing module 101 executes various kinds of processing for providing the information sharing service to each user. For example, the service providing module 101 provides each function in the information sharing service to each user. In the at least one embodiment, an app is mainly described as an example of the function, and hence the service providing module 101 provides the information sharing service by displaying a screen that shows information registered in the app on the user terminal 20. The screen itself may be a known screen, and may be, for example, a screen for displaying information registered in the app in a table format.

For example, the service providing module 101 also executes processing for providing another function different from an app. For example, in a case of the schedule sharing function, the service providing module 101 executes processing for registering a schedule of a certain user in the server 10 and processing for displaying a schedule screen including the schedule on the user terminal 20 of each of the certain user and other users. The schedule of each user in the group is displayed on the schedule screen. Each user can change the schedules of other users and write comments on the schedules of other users.

For example, in a case of the file sharing function, the service providing module 101 executes processing for registering a file uploaded by a certain user in the server 10 and processing for transmitting the uploaded file to (allowing the file to be downloaded on) the user terminal 20 of each of the certain user and other users. Similarly in a case of another function such as the database sharing function or the communication function, the service providing module 101 executes processing corresponding to the other function. The service providing module 101 changes the content of the data storage unit 100 as the requirement arises.

In the at least one embodiment, when the user uses a certain function, the service providing module 101 updates the use statuses of this function stored in the use status database DB2. For example, when the user uses a certain app, the service providing module 101 increases the number of times of access associated with the function ID of the certain app. For example, when an app is provided on a browser, a URL for displaying a screen of each app is defined for the app. Thus, when the URL of a certain app is accessed, the service providing module 101 determines that the certain app has been used to increase the number of times of access.

For example, when an app is provided on a program dedicated to the information sharing service instead of the browser, the function ID of an app designated by the user is transmitted from the user terminal 20 to the server 10. When the function ID is received from the user terminal 20, the service providing module 101 determines that the app of the received function ID has been used to increase the number of times of access. When the same user uses the app a plurality of times in a given day, the service providing module 101 may increase the number of times of access each time, or may increase the number of times of access by only one.

Similarly when other information different from the number of times of access corresponds to the use status, the service providing module 101 is only required to update the use statuses in the use status database DB2 based on the information received from the user terminal 20. For example, the service providing module 101 may store the user ID of the user who has accessed the app, the date and time of access to the app, and the specific operation detail in the use status database DB2 as the use statuses. Similarly when a function other than the app is used, the service providing module 101 is only required to update the use statuses in the use status database DB2 each time the other function is used.

[Use Status Acquisition Module]

The use status acquisition module 102 acquires the statuses of use by each of the plurality of users for each function. In the at least one embodiment, the use statuses are stored in the use status database DB2, and hence the use status acquisition module 102 refers to the use status database DB2 to acquire the use statuses of each function. In the at least one embodiment, the use status acquisition module 102 acquires the number of times of access to the function as the use status of the function.

When the use statuses are stored in a database other than the use status database DB2, the use status acquisition module 102 is only required to refer to the other database to acquire the use statuses of each function. The use statuses themselves may not be stored in the database, but the use status acquisition module 102 may acquire the use statuses by aggregating the behavior status on the spot based on behavior histories of users in the information sharing service. In this case, it is assumed that the behavior histories of users are stored in the user database DB1 or another database. Meanwhile, when the use statuses are stored on the user terminal 20 or another computer instead of the server 10, the use status acquisition module 102 may acquire the use statuses from the user terminal 20 or the other computer.

In the at least one embodiment, a plurality of apps, which are examples of the functions, are each added by any one of the plurality of users. The addition indicates that a new function becomes available. Recording new function data in the server 10 corresponds to the addition. For example, when the user logs into the information sharing service and performs setting work for adding an app, the app is added based on the setting work. The app may be added by known processing. For example, when setting work for setting a name of an app, a layout of a table including the number of fields and field names, a format of data that can be input, and whether or not comments can be input for the app is performed, the app is added based on the setting work.

For example, when an app is added, data corresponding to the app is generated and recorded in the data storage unit 100. A program required for the app is also generated and recorded in the data storage unit 100. The login to the information sharing service is not required for the addition of an app, and the user may add the app in advance through offline work using an app addition tool installed on the user terminal 20. In this case, the user may upload the app stored in the user terminal 20 onto the server 10.

For example, the use status acquisition module 102 acquires the use statuses of an app added by any one of the plurality of users. The user who can add an app may be a user who has administrative authority for the group, or may be a user who does not particularly have administrative authority. It is assumed that administrative authority for an app is granted to the user who has added the app. The use status database DB2 stores not only the use statuses of the app added by the user himself or herself but also the use statuses of the apps provided in advance by the information sharing service, and hence the use status acquisition module 102 acquires the use statuses of those apps.

Other functions different from the apps may be added by each user. For example, the user may be able to add a schedule sharing function by himself or herself. In this case, the user designates a layout of a screen for schedule sharing and adds macros to be executed for the schedule sharing. The data of the schedule sharing function added by the user is recorded in the data storage unit 100. Another function may be addable by the user himself or herself in the same manner. The function may be added through use of a plug-in.

[Processing Execution Module]

The processing execution module 103 executes, for each function, predetermined processing relating to the function based on the use status of the function. In the at least one embodiment, the number of times of access corresponds to the use status, and hence the processing execution module 103 executes the predetermined processing based on the number of times of access to the function. In the at least one embodiment, the user can add an app, which is an example of the function, by himself or herself, and hence the processing execution module 103 executes the predetermined processing based on the number of times of access to the app added by any one of the plurality of users.

The predetermined processing is processing to be executed based on a use status acquired by the use status acquisition module 102. The predetermined processing may be any processing defined in advance as long as the predetermined processing is processing corresponding to a purpose for which the use status has been acquired. In the at least one embodiment, the processing execution module 103 executes, as the predetermined processing, use status display processing for displaying the use status of the function on the user terminal 20. Thus, the use status display processing as used herein can be read as “predetermined processing.” Other examples of the predetermined processing are described later in Modification Examples 1 to 6.

The use status display processing is image processing for displaying a use status screen that shows the use status of each function. In the at least one embodiment, the processing execution module 103 is implemented by the server 10, and hence the use status display processing is processing for generating display data of the use status screen and transmitting the data to the user terminal 20. The display data may have any format, and when a browser is used as in the at least one embodiment, the display data may have an HTML format. The display data may be data of a part of the screen, such as an image or a video, instead of the data of the entire screen.

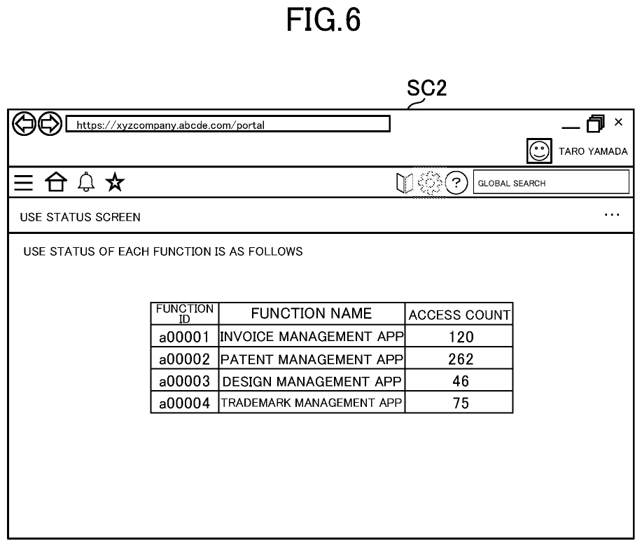

FIG. 6 is a view for illustrating an example of the use status screen. In the at least one embodiment, a case in which a use status screen SC2 for an app to be managed by the administrative user who has the administrative authority is displayed on the user terminal 20 of the administrative user is described. For example, when the administrative user performs an operation for displaying the use status screen SC2 from the portal screen SC1 or another screen, the processing execution module 103 displays the use status screen SC2 of FIG. 6 on the user terminal 20 of the administrative user.

For example, on the use status screen SC2, the function ID of an app, which is an example of the function, the name of the app, and the number of times of access, which is an example of the use status, are displayed on the use status screen SC2. On the use status screen SC2, the numbers of times of access to all apps to be managed may be displayed, or the numbers of times of access to only some apps may be displayed. The processing execution module 103 generates display data of the use status screen SC2 based on the numbers of times of access to apps to be displayed on the use status screen SC2 and transmits the display data to the user terminal 20, to thereby execute the use status display processing.

For example, the processing execution module 103 may display, on the user terminal 20, the use status screen SC2 that shows the number of times of access for each department or the number of times of access for each user instead of the number of times of access to a certain app in the entire group. On the use status screen SC2, the numbers of times of access may be displayed in another format such as a bar chart or a pie chart instead of such a table format as shown in FIG. 6. For example, the chart or table format for displaying the numbers of times of access may be switched by an operation of the administrative user.

In the at least one embodiment, a case in which the use status screen SC2 is displayed on the user terminal 20 of the administrative user is described, but the processing execution module 103 may execute use status display processing for displaying the use status of each app on the user terminal 20 of the general user. That is, the use status screen SC2 may be displayed not only on the user terminal 20 of the administrative user but also on the user terminal 20 of the general user.

For example, when the processing execution module 103 receives a display request for the use status screen SC2 from the user terminal 20 of a general user, the processing execution module 103 generates display data of the use status screen SC2 including the number of times of access to the app to be displayed and transmits the display data to the user terminal 20. Similarly when display of another use status different from the number of times of access is requested, the processing execution module 103 is only required to generate display data of the use status screen SC2 including the other use status. The same applies when display of another function different from the app is requested.

The use status screen SC2 for the general user and the use status screen SC2 for the administrative user may be the same, or may partially or entirely differ from each other. For example, when an app for which the number of times of access thereto can be displayed only on the use status screen SC2 for the administrative user is defined, the number of times of access to the app may not be displayed on the use status screen SC2 for the general user. For example, there may be provided such a limitation that, while the number of times of access to the app during any period can be displayed on the use status screen SC2 for the administrative user, only the number of times of access to the app during a specific period can be displayed on the use status screen SC2 for the general user. For example, on the use status screen SC2 for the general user, only the use status of the general user may be displayed instead of the use status of the entire group. Meanwhile, on the use status screen SC2 for the administrative user, the display of the use status may be able to be switched between, for example, the use status of the entire group, the use status of each department, and the use status of each individual general user.

The processing execution module 103 can also execute the use status display processing for another function different from the app in the same manner. For example, the processing execution module 103 may execute use status display processing for displaying the number of times of access to the schedule sharing function and the number of times of access to the file sharing function on the use status screen SC2. The use status display processing may be processing for displaying the specific operation detail of the user as another use status different from the number of times of access. The use status display processing may be any processing for displaying the use status acquired by the use status acquisition module 102.

### 3-2. Apps Implemented by User Terminal

A data storage unit 200 is implemented by the storage unit 22. A display control module 201 and an operation receiving module 202 are implemented by the control unit 11.

[Data Storage Unit]

The data storage unit 200 stores data required for providing the information sharing service to the user. For example, the data storage unit 200 stores a browser for displaying various screens relating to the information sharing service. For example, the data storage unit 200 stores a program dedicated for the information sharing service.

[Display Control Module]

The display control module 201 displays various screens relating to the information sharing service on the display unit 25. For example, the display control module 201 displays, on the display unit 25, the portal screen SC1, the use status screen SC2, or other screens based on the display data received from the server 10.

[Operation Receiving Module]

The operation receiving module 202 receives various operations in the information sharing service. For example, the operation receiving module 202 receives an operation for accessing an app, an operation for editing a record within an app, or an operation for displaying detailed information within an app. Those operation details are transmitted to the server 10 as appropriate.

### 4. Processing to be Executed by Information Sharing System

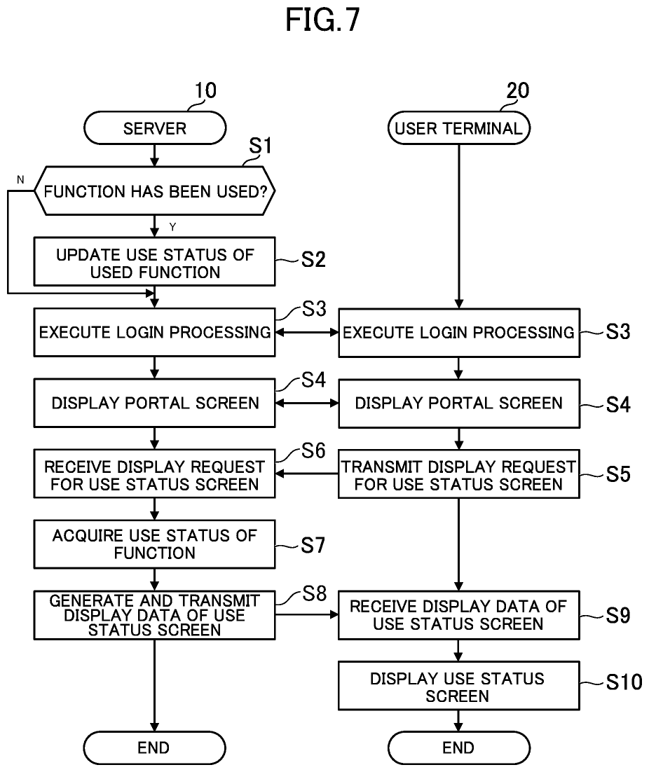

FIG. 7 is a flow chart for illustrating an example of processing to be executed by the information sharing system 1. Of different kinds of processing to be executed by the information sharing system 1, the use status display processing for displaying the use status screen SC2 on the user terminal 20 of the administrative user is mainly described with reference to FIG. 7. Details of processing for using functions such as apps are omitted in FIG. 7.

As illustrated in FIG. 7, the server 10 determines whether or not any one of a plurality of functions has been used based on the information received from the user terminal 20 (Step S1). When it is determined that any one of the functions has been used (Y in Step S1), the server 10 updates the use status of the function determined to have been used in Step S1, which is stored in the use status database DB2 (Step S2). For example, each time an app is used, the processing step of Step S2 is executed, and the number of times of access to the app increases each time. Another use status different from the number of times of access is also updated. Even when another function different from the app is used, the use status is updated in the processing step of Step S2.

The user terminal 20 of the administrative user cooperates with the server 10 to execute login processing for the administrative user to log into the information sharing service (Step S3). When the login processing is successful, the user terminal 20 cooperates with the server 10 to execute the processing for displaying the portal screen SC1 (Step S4). When the administrative user performs the operation for displaying the use status screen SC2 from the portal screen SC1 or another screen, the user terminal 20 transmits a display request for the use status screen SC2 to the server 10 (Step S5).

When the server 10 receives the display request for the use status screen SC2 (Step S6), the server 10 refers to the use status database DB2 to acquire the use statuses of functions to be managed (Step S7). In the at least one embodiment, a case in which all apps of a group to which the administrative user belongs are to be managed is described, but administrative authority may be set for each app, and only apps of each of which the administrative authority has been granted to the administrative user may be to be managed. When the display of another use status different from the number of times of access to the app is requested, the other use status is acquired in Step S7. Even when the display of the use status of another function different from the app is requested, the use status of the other function is acquired in Step S7.

The server 10 generates display data of the use status screen SC2 based on the number of times of access to the app to be managed, which is acquired in Step S7, and transmits the display data to the user terminal 20 (Step S8). When the user terminal 20 receives the display data of the use status screen SC2 (Step S9), the user terminal 20 displays the use status screen SC2 on the display unit 25 based on the display data (Step S10), and this processing is ended. After that, the administrative user views the use status screen SC2 to consider whether or not to delete an app that has not been frequently used or consider whether or not to modify an app that has been frequently used recently.

The information sharing system 1 in the at least one embodiment executes, for each function, the predetermined processing relating to the function based on the use status of the function. It can be analyzed in detail to what extent or how each individual function has been used by acquiring not the use status of the entire information sharing service but the use status of each individual function and executing the predetermined processing therefor, thereby increasing the convenience of each user in the information sharing service.

Further, the information sharing system 1 executes the use status display processing as the predetermined processing. With this execution, it becomes easier for the user to view the use status of each individual function. For example, the administrative user is enabled to consider whether or not to stop a function that has not been frequently used or consider whether or not to modify a function that has been frequently used recently. For example, when the use status display processing for displaying the use status of the function on the user terminal 20 of the general user is executed, it becomes easier for the general user to view the use status of each individual function.

Further, the information sharing system 1 acquires the number of times of access to the function as the use status of the function. It becomes easier to analyze to what extent each individual function has been used by acquiring an easy-to-understand index such as the number of times of access.

Further, the information sharing system 1 acquires the use status of functions added by the user. When users are enabled to add functions by themselves, a large number of functions are added to the information sharing service, and management of the functions may become complicated. For example, it may be impossible to distinguish between functions that have been frequently used and functions that have not been frequently used. In this respect, acquiring the use status of each function facilitates the management of a large number of functions.

### 5. Modification Examples

The present disclosure is not limited to the at least one embodiment described above, and can be modified suitably without departing from the spirit of the present disclosure.

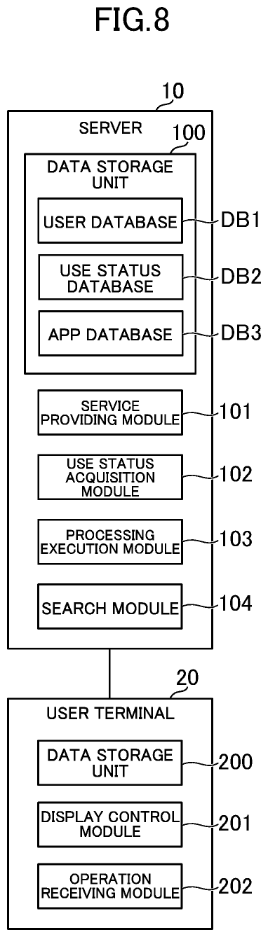

FIG. 8 is a diagram for illustrating functional blocks implemented in modification examples. A search module 104 is implemented by the control unit 11.

### 5-1. Modification Example 1

For example, the predetermined processing to be executed by the processing execution module 103 is not limited to the use status display processing described in the at least one embodiment. The predetermined processing may be any processing corresponding to a purpose for which the use status has been acquired. In Modification Examples 1 to 6, other examples of the predetermined processing are described. It suffices that the processing execution module 103 can execute all or some of the kinds of predetermined processing described in the at least one embodiment and Modification Examples 1 to 6. In Modification Example 1 as well, the app is described as an example of the function.

For example, the processing execution module 103 may execute, as the predetermined processing, function stop processing for stopping an app of which use by each of the plurality of users satisfies a first criterion among the plurality of apps. The first criterion is a condition as to whether or not to execute the function stop processing. In Modification Example 1, the case in which relatively less frequent use of a function corresponds to a first criterion is taken as an example, but the first criterion may be another criterion. For example, instead of the relatively less frequent use, the first criterion may be no use by the user, the number of times of use by the user being smaller than a threshold value, or an elapsed time period since the last use being equal to or longer than a predetermined time period. The relatively less frequent use of an app refers to the number of times of use of (for example, number of times of access to) the app being smaller than those of other apps. For example, when the apps are ranked in descending order of the number of times of use of the app, the apps ranked lower than a predetermined rank correspond to apps of which the use is relatively less frequent.

The function stop processing in Modification Example 1 is processing for stopping the use of an app itself. When the function stop processing is executed, the app becomes unusable to all users. For example, the processing execution module 103 determines for each app whether or not the use of the app by all users who can use the app has become less frequent. The less frequent use corresponds to the number of times of use of (for example, number of times of access to) the app being smaller than a predetermined threshold value. For example, a case in which the number of times of use during a certain first period is equal to or larger than a threshold value but the number of times of use during a second period, which is later than the first period, is smaller than the threshold value corresponds to the number of times of use of the app becoming smaller. The processing execution module 103 executes the function stop processing by removing links to all user IDs associated with the function ID of the app to be stopped.

The function stop processing may be other processing, and is not limited to the above-mentioned example. For example, the processing execution module 103 may delete the record itself of the app to be stopped from an app database DB3, to thereby stop the use of the app. For example, when the user ID of a certain user and the function ID of an app that the user is permitted to use are associated with each other in the user database DB1, the processing execution module 103 may remove all such links therebetween in the user database DB1, to thereby execute the function stop processing. As another example, processing for displaying a list of apps that have been relatively less frequently used on the user terminal 20 of the administrative user and stopping the use of the apps in accordance with an operation of the administrative user may correspond to the function stop processing. The function stop processing may be executed in the same manner for other functions different from the apps.

The information sharing system 1 in Modification Example 1 executes the function stop processing as the predetermined processing. Accordingly, the function that satisfies the first criterion is stopped, and the administrative user is no longer required to manually stop the function, and hence a burden on the administrative user can be reduced.

### 5-2. Modification Example 2

For example, the app added by the user is basically free of charge, but an app and another function different from the app that are provided in advance by the information sharing system may be chargeable. For example, in regard to a chargeable function, the user may be allowed to freely decide whether or not to continue a contract for the function, or may be allowed to change a contract plan thereof. In the information sharing service in Modification Example 2, a contract can be made for each function. As a mechanism itself for making a contract for each function, any one of various known contracting mechanisms can be used.

The processing execution module 103 in Modification Example 2 executes, as the predetermined processing, contracting processing for making a contract corresponding to the use status of a function. The contracting processing may be processing for automatically determining whether or not to continue the contract or automatically changing the contract plan. However, in Modification Example 2, a case in which processing for proposing to the user whether or not to continue the contract or prompting the user to change the contract plan corresponds to the contracting processing is described. For example, the processing execution module 103 executes the contracting processing by displaying information relating to the contract on the use status screen. In Modification Example 2 as well, the app is described as an example of the function.

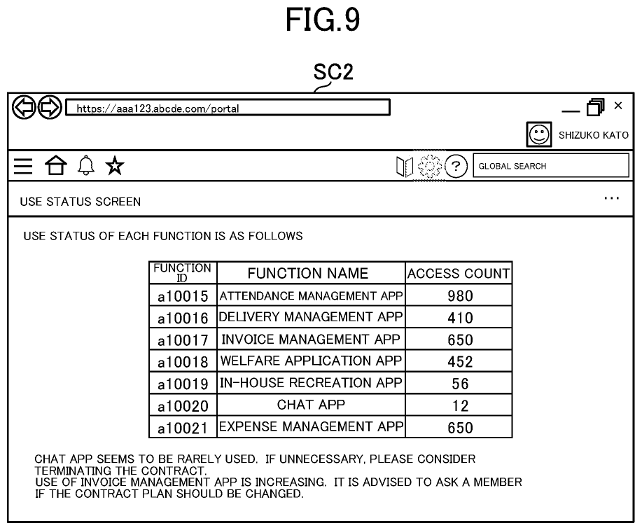

FIG. 9 is a view for illustrating an example of the use status screen SC2 in Modification Example 2. For example, the processing execution module 103 executes the contracting processing by displaying, on the use status screen SC2, a message for prompting the user to terminate the contract for an app that has been relatively less frequently used. For example, the processing execution module 103 may display, on the use status screen SC2, a message for prompting the user to change the current contract plan of the app that has been relatively less frequently used to a less expensive contract plan or to stop the continuous use itself, to thereby execute the contracting processing. It may be determined whether or not the use is relatively less frequent by the same method as that employed in Modification Example 2.

In the example of FIG. 9, an app for which the number of times of access thereto is smaller than a threshold value corresponds to the app that has been relatively less frequently used. For example, the number of times of access to a chat app is smaller than the threshold value, and hence a message for prompting the user to delete the chat app and stop the continuous use is displayed on the use status screen SC2. The processing execution module 103 may automatically stop the continuous use of the chat app or may automatically change the current contract plan to a less expensive contract plan.

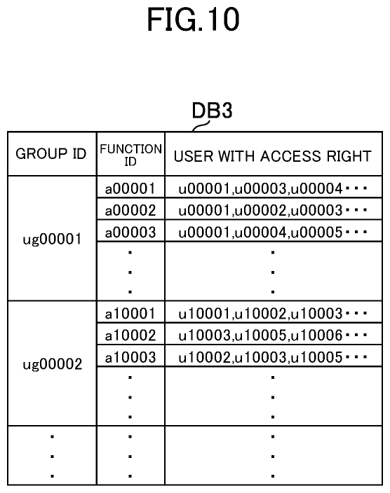

In contrast, the processing execution module 103 may display, on the use status screen SC2, a message for prompting the user to change the current contract plan of an app that has been increasingly frequently used to a more expensive contract plan, to thereby execute the contracting processing. In the example of FIG. 10, the number of times of access to a billing management app tends to be increasing, and hence a message for prompting the user to change the contract plan is displayed on the use status screen SC2. The processing execution module 103 may automatically change the current contract plan of the billing management app to a more expensive and more convenient contract plan. In regard to another function different from the app, the contracting processing corresponding to the use status of the other function may be executed in the same manner.

The information sharing system 1 in Modification Example 2 executes the contracting processing as the predetermined processing. Accordingly, it becomes easier for the user to review the contract for the currently used function, thereby increasing the convenience of each user.

### 5-3. Modification Example 3

For example, the use status acquisition module 102 may acquire, as the use status, the user ID of a user who has accessed information provided by a function among the plurality of users. The information provided by a function is information shared through use of the function. For example, in a case of an app, information of a record included in a table that can be displayed by the app or information included in a portion other than the record corresponds to the information provided by the app. For example, in the case of the schedule sharing function, schedules and comments that can be displayed on a schedule screen correspond to the information provided by the schedule sharing function. In Modification Example 3, it is assumed that the use status database DB2 stores, for each piece of information provided by each individual function, the user ID of the user who accessed the information.

The user ID is an example of user identification information. Thus, the user ID as used herein can be read as “user identification information.” The user identification information is not limited to the user ID as long as the user identification information can identify a user. For example, the user identification information may be an email address, a telephone number, or information called “user account” rather than the user ID.

The processing execution module 103 in Modification Example 3 executes the predetermined processing based on the user ID for an app. Thus, the predetermined processing in Modification Example 3 is processing executed based on the user ID of the user who accessed the information provided by the app. In a case of the use status display processing described in the at least one embodiment, the processing execution module 103 executes the use status display processing for displaying the use status screen SC2 that shows the user ID of the user who accessed the information provided by the function.

For example, the administrative user, who wishes to impose a limitation on the user who can access a specific record in the app, may be enabled to set an access right for the specific record. The administrative user performs work for setting the access right for a specific record by designating users who can access the record. When the administrative user makes a mistake in the setting work, the specific record may be able to be adversely accessed by a user who is not supposed to have access thereto. In this case, the processing execution module 103 may execute the predetermined processing by notifying the administrative user of the user ID of the user who has accessed the specific record.

For example, the processing execution module 103 may change the access right of a user who rarely accesses information provided by a certain app, to thereby execute the predetermined processing. The processing execution module 103 may change the access right so that the user who rarely accesses a record of the certain app cannot access the record. As another example, the processing execution module 103 may transmit a notification for prompting a user who rarely uses a certain app to use the app. In regard to another function different from the app, the predetermined processing described above may be executed in the same manner.

The app may enable access rights to be set therefor so that only specific users can use the app. For example, access rights are set so that an app in a certain group can be used only by some of the plurality of users belonging to the group. The access right to an app is designated by the administrative user who has the administrative authority for the app. The data storage unit 100 in Modification Example 3 stores the app database DB3 in which access rights to apps are defined. The data storage unit 100 may store a database in which access rights to other functions different from the apps are defined.

FIG. 10 is a table for showing an example of the app database DB3. For example, in the app database DB3, the group ID, the function ID of each of a plurality of apps, and the user ID of a user who has an access right to the app are associated with each other. When a request to use a certain app is transmitted from the user terminal 20 of a certain user, the service providing module 101 refers to the app database DB3 to determine whether or not the user ID of the certain user is associated with the function ID of the certain app. The service providing module 101 does not permit use of the certain app when those are not associated, and permits the use of the certain app when those are associated.

For example, in a case of displaying the portal screen SC1 on the user terminal 20 of a certain user, the service providing module 101 may refer to the app database DB3 to identify apps to which the certain user has the access right and may display only the identified apps in the display area A10. The app database DB3 may store the user ID of a user who does not have the access right to an app instead of the user ID of the user who has the access right to the app.

The processing execution module 103 in Modification Example 3 may execute, as the predetermined processing based on the user identification information, use stop processing for stopping use by a user who has used an app relatively less frequently among the plurality of users. The user who has used an app relatively less frequently is a user having the number of times of use of (for example, the number of times of access to) the app smaller than those of other users or a predetermined threshold value. For example, when the users are ranked in descending order of the number of times of use of the app, the users ranked lower than a predetermined rank correspond to users who have used the app relatively less frequently. For example, a user who has never used the app or a user having the number of times of use of the app smaller than a threshold value corresponds to the user who has used the app relatively less frequently. The threshold value may be a fixed value, or may be determined based on the numbers of times of use by all users.

In Modification Example 3, the user ID of the user who has accessed the app and the date and time of access to the app are referred to from among the use statuses stored in the use status database DB2 of FIG. 5. The use status acquisition module 102 acquires those use statuses. It may be aggregated whether or not the use of the app is relatively less frequent for the entire past period or for the most recent part of the period. In Modification Example 3, a case in which never using an app for the last six months corresponds to the relatively less frequent use of the app is taken as an example.

The processing execution module 103 identifies, for each app, a user who has used the app relatively less frequently based on the use statuses of the app. For example, for each app, the processing execution module 103 identifies, as the user who has used the app relatively less frequently, a user who has never used the app for the last six months from among the users who have the access right to the app. For example, the processing execution module 103 sets the access right so that the user who has used the app relatively less frequently cannot use the app, to thereby execute the use stop processing.

The use stop processing may be other processing, and is not limited to the above-mentioned example. For example, in a case in which the user ID of a certain user and the function ID of an app to which the certain user has the access right are associated with each other in the user database DB1, the processing execution module 103 may change the setting of the access right in the user database DB1 when the use of the app by the certain user has become less frequent, to thereby execute the use stop processing. As another example, processing for displaying a list of users who have used the app relatively less frequently on the user terminal 20 of the administrative user and setting the access right in accordance with an operation of the administrative user may correspond to the use stop processing. The use stop processing may be executed in the same manner for another function different from the app.

The information sharing system 1 in Modification Example 3 executes the predetermined processing based on the user ID of the user who has accessed the information provided by the app among the plurality of users. Accordingly, for example, it is possible to analyze in detail which user has accessed the information and to automatically set the access right, thereby increasing the convenience in the information sharing service. For example, when a specific record of a certain app is restricted so that the specific record can be accessed only by a specific user, it becomes easier for the administrative user to examine whether or not the specific record can be adversely accessed by a user who is not supposed to have access thereto due to erroneous setting of the access right. When such access occurs, a predetermined notification may be transmitted to the administrative user. For example, when the use stop processing is executed as the predetermined processing, the use by the user who rarely uses the function, which is exemplified by the app, is stopped, and the administrative user is no longer required to manually change the access rights. Accordingly, a burden on the administrative user can be reduced.

### 5-4. Modification Example 4

In Modification Example 4, as an example of the function, a thread function for enabling communication using a thread, which is a type of bulletin board, is described. For example, the processing execution module 103 may execute, as the predetermined processing, information display processing for displaying a piece of information of which the use by each of the plurality of users satisfies a second criterion among a plurality of pieces of information provided by the thread function.

The information provided by the thread function refers to information such as comments posted on the thread. The second criterion is a condition as to whether or not to execute the information display processing. In Modification Example 4, a case in which having been frequently viewed corresponds to the second criterion is taken as an example, but the second criterion may be another criterion. For example, the second criterion may be any one of having been viewed by a specific user, the number of likes being equal to or larger than a threshold value, the number of replies being equal to or larger than a threshold value, a specific phrase being contained by the number equal to or larger than a threshold value, or the number of backlinks being equal to or larger than a threshold value. The frequently viewed information refers to information to which the number of times of access is equal to or larger than a threshold value. In Modification Example 4, it is assumed that, for each individual piece of information provided by the thread function, the number of times of access to the each individual piece of information is stored in the use status database DB2.

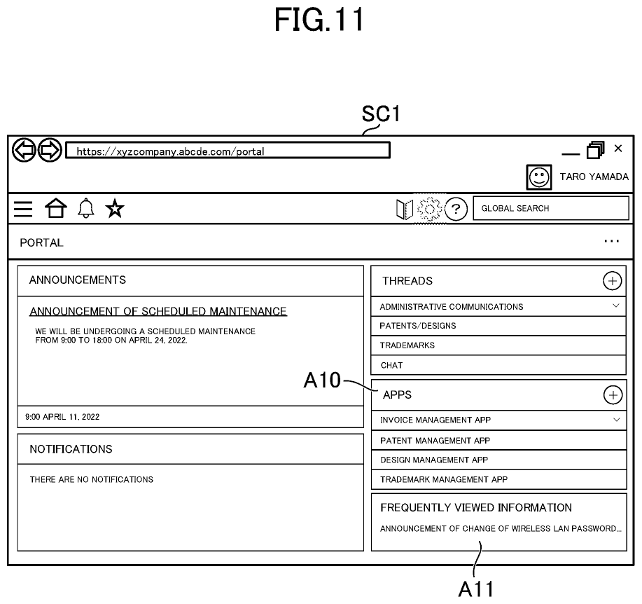

FIG. 11 is a view for illustrating an example of the portal screen SC1 in Modification Example 4. The example of FIG. 11 shows a case in which the frequently viewed information is displayed in a display area A11 of the portal screen SC1. It is assumed that the use status in Modification Example 4 is acquired for each piece of information exchanged in a thread created by the thread function. The use status may be acquired for each individual post in the thread. Thus, the use status acquisition module 102 acquires the use status for each piece of information in the thread. The processing execution module 103 identifies the frequently viewed information based on the use status of each piece of information in the thread. The processing execution module 103 executes the information display processing by displaying the frequently viewed information or links thereto on the portal screen SC1.

The information display processing can also be applied to other functions different from the thread function. For example, when the app corresponds to the function, processing for displaying the frequently viewed information among a plurality of pieces of information registered in the app may correspond to the information display processing. For example, when the schedule sharing function corresponds to the function, processing for displaying the frequently viewed information among a plurality of pieces of information registered in the schedule sharing function may correspond to the information display processing. For other functions, the frequently viewed information may be displayed by the information display processing in the same manner.

The information sharing system 1 in Modification Example 4 executes the information display processing as the predetermined processing. Accordingly, it becomes easier for the user to notice the frequently viewed information in the information sharing service, thereby increasing the convenience of each user.

### 5.5. Modification Example 5

For example, the processing execution module 103 may execute, as the predetermined processing, authority change processing for changing authority relating to a piece of information of which use by each of the plurality of users satisfies a third criterion among a plurality of pieces of information provided by the function.

The third criterion is a condition as to whether or not to execute the authority change processing. In Modification Example 5, a case in which the number of times of use of the app is smaller than a threshold value corresponds to the third criterion, but the third criterion may be another criterion. For example, the third criterion may be any one of the app having been viewed but not having been updated, no comments having been posted to the app, no reactions having been made to comments of other users, not having been viewed by a specific user, a specific reaction having been made the number of times equal to or larger than a threshold value, or the date and time of creation being a threshold value before or earlier. The processing for changing the access right to the record of the app, which is described in Modification Example 3, is a kind of authority change processing. In Modification Example 5, kinds of processing that have not been described in Modification Example 3 can also be executed as the authority change processing. Modification Example 5 is described by again taking the app as an example of the function.

For example, the authority change processing may be processing for archiving information of the app so that the information cannot be updated. The archiving prevents the information of the app from being further updated. Through the archiving, data may be compressed with the data format changed. For example, the archiving may be executed by changing the information of the app that has been data having a table format to information having a text format. For example, the archiving may be executed by saving image data representing a screenshot of a screen that shows certain information. Any one of various known methods can be used as an archiving method itself. The processing execution module 103 may archive an app that is no longer viewed.

The information sharing system 1 in Modification Example 5 executes the authority change processing as the predetermined processing. Accordingly, for example, the administrative user is no longer required to manually change the access right, and hence a burden on the administrative user can be reduced. For example, in a case of archiving certain information so as to prevent the certain information from being further updated, it is possible to reduce time and labor for the administrative user to manually perform the archiving in the same manner. Through the archiving, information can be compressed in size, and hence it is possible to reduce a memory consumption amount.

### 5-6. Modification Example 6

For example, the predetermined processing may be processing for causing information to be easily hit in a search in the information sharing service. The information sharing system 1 in Modification Example 6 includes the search module 104. The search module 104 searches information provided by each of the plurality of functions based on a search condition input by each of the plurality of users. In Modification Example 6, a search within an app is taken as an example, but a search range is not limited to within the app. For example, information of the thread or another function may be subjected to a search, or a search may be executed across a plurality of functions. For the search itself, any one of methods employed by various search engines can be used.

The processing execution module 103 in Modification Example 6 may execute, as the predetermined processing, hit processing for causing information provided by the frequently used app among the plurality of apps to be easily hit in a search. For example, the processing execution module 103 adjusts a search score of information of a certain app so that the search score becomes higher as the number of times of access to the certain app becomes larger, to thereby execute the hit processing. The processing execution module 103 may execute the hit processing by searching only apps to each of which the number of times of access is equal to or larger than a threshold value.

In regard to another function different from the app, information of the frequently used function may be caused to be easily hit in a search in the same manner. For example, in a certain function, when there are flow information that flows away on the spot and stock information being information accumulated without flowing away on the spot, the stock information may be searched with a higher priority than the flow information. In this case, the processing execution module 103 may change information of the frequently used function from flow information to stock information, to thereby cause the information to be easily hit in a search. In this case, it is assumed that an attribute indicating a distinction between flow information and stock information is set for each individual piece of information. The processing execution module 103 changes flow information to stock information by changing the attribute of the information.

The information sharing system 1 in Modification Example 6 executes the hit processing as the predetermined processing. Accordingly, the information of the frequently viewed function can be caused to be easily hit in a search, and hence convenience in the search can be increased.

### 5-7. Modification Example 7

For example, each of the plurality of functions may be provided to each of the plurality of users through use of an API for the provided function. The service providing module 101 in Modification Example 7 uses an API for a certain function to provide the certain function. For example, when the service providing module 101 receives a request for an API for a certain function from the user terminal 20, the service providing module 101 provides the certain function to the user based on the request for the API. As a method itself of providing a function through use of an API, any one of various methods can be used. For example, there may be APIs such as an API for the schedule sharing function, an API for the file sharing function, and an API corresponding to each individual app. The use status acquisition module 102 in Modification Example 7 acquires the use status of a function through use of the API for the function.

In Modification Example 7, a case in which the administrative user who is a labor manager manages an arriving-at-and-leaving-work state and working hours of each general user who is an employee to be managed is taken as an example. Thus, the information sharing service in Modification Example 7 has an attendance management function. The attendance management function is a function for managing times at which the user arrives at work and leaves work. For example, when the service providing module 101 receives, from the user terminal 20, a notification that the user has arrived at work, the service providing module 101 uses the attendance management function to store the arrival time of the user in the user database DB1. When the service providing module 101 receives, from the user terminal 20, a notification that the user has left work, the service providing module 101 uses the attendance management function to store the leaving time of the user in the user database DB1.

For example, the attendance management function may be a part of the schedule sharing function. In this case, information for the administrative user to grasp actual states of meetings and visits of the general users or the entire organization may be acquired based on the use status of the schedule sharing function through use of the API for the schedule sharing function. That is, the use status acquisition module 102 may use the API for the schedule sharing function to acquire the use status of the schedule sharing function in order to obtain statistics of schedule information for each general user. The acquired use status may be a schedule itself registered by each individual general user through use of the schedule sharing function.

For example, the use status acquisition module 102 uses the API for the schedule sharing function to acquire, as the use statuses, the number and total time period of schedules (such as visiting or vacation schedules) for each menu indicating the schedules of the general users, loads relating to meetings of individuals, the number and total hours of schedules within regular working hours, the number and total hours of overtime schedules, the number and total hours of recurring schedules within a certain time period, the statistics of the schedule information in units of organizations and groups, loads relating to meetings of the organizations and groups, the number and total hours of recurring schedules of the organizations, and users who have often participated in schedules in the organizations and groups.

The use statuses described in Modification Example 7 are statistics for use by the administrative user in charge of labor management, and hence the use status acquisition module 102 becomes able to acquire information required by the labor manager. For example, the use status acquisition module 102 may use the API for the schedule sharing function to acquire time periods for vacations or temporary leaves, early arrivals, and overtime hours (in combination with timecards). In Modification Example 7, the schedule sharing function has been taken as an example, but in regard to the various apps and other various functions described in the at least one embodiment and Modification Examples 1 to 6, the use status acquisition module 102 may use the API for each individual function to acquire the use status in the same manner.

The information sharing system 1 in Modification Example 7 acquires the use status of the function through use of the API for the function. When an individual function is provided through use of an API, a request with respect to the API is always generated, and hence the use status of the function can be acquired more accurately by acquiring the use status through use of the API.

### 5-8. Modification Example 8

For example, the use status acquisition module 102 may acquire, as the use status of a function, the display time period during which a screen relating to the function is being displayed. The display time period is a time period from the start of display of a screen of a certain function until the end thereof. For example, when the app corresponds to the function, a time period during which a screen relating to each individual app is being displayed on the user terminal 20 corresponds to the display time period. The same applies to the other functions. For example, in the case of the schedule sharing function, a time period during which the schedule screen is being displayed corresponds to the display time period. In the case of the thread function, a time period during which the screen of each individual thread is being displayed corresponds to the display time period.

The service providing module 101 in Modification Example 8 starts timing when the screen of a certain function is displayed on the user terminal 20, and measures the time until transition to another screen, to thereby measure the display time period of the certain function. The service providing module 101 stores the measured display time period in the use status database DB2 as the use status. The use status acquisition module 102 acquires, as the use status, the display time period of each individual function stored in the use status database DB2.

The processing execution module 103 in Modification Example 8 executes the predetermined processing based on the display time period of the function. The predetermined processing may be any one of kinds of processing described in the at least one embodiment or Modification Examples 1 to 7. For example, the processing execution module 103 executes the use status display processing for displaying the display time period of each individual function on the use status screen SC2. For example, the processing execution module 103 executes the use stop processing for stopping the use of the function by a user having a relatively short display time period. Other kinds of predetermined processing may be executed based on the display time period in the same manner.

The information sharing system 1 in Modification Example 8 executes the predetermined processing based on the display time period during which the screen relating to the function is being displayed. Accordingly, it is possible to analyze how well the user views the screen of a certain function.

### 5-9. Other Modification Examples

For example, the above-mentioned modification examples may be combined.

For example, each function described above may be implemented by any device in the information sharing system 1. For example, the functions described as being implemented by the server 10 may be implemented by the user terminal 20. In this case, it suffices that the same processing as that executed by the server 10 is executed by a script of a browser or by a program installed on the user terminal 20. For example, the functions may be divided among a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information sharing system, comprising at least one processor configured to:
acquire a use status of use by each of a plurality of users for each of a plurality of functions relating to an information sharing service for sharing information; and
execute, for each of the plurality of functions, predetermined processing relating to the each of the plurality of functions based on the use status of the each of the plurality of functions.

2. The information sharing system according to claim 1, wherein the at least one processor is configured to execute, as the predetermined processing, use status display processing for displaying the use status of the each of the plurality of functions on a user terminal.

3. The information sharing system according to claim 1, wherein the at least one processor is configured to execute, as the predetermined processing, function stop processing for stopping a function of which use by each of the plurality of users satisfies a first criterion among the plurality of functions.

4. The information sharing system according to claim 1,
wherein the information sharing system allows a contract to be made for each of the plurality of functions, and
wherein the at least one processor is configured to execute, as the predetermined processing, contracting processing for making the contract corresponding to the use status of the each of the plurality of functions.

5. The information sharing system according to claim 1, wherein the at least one processor is configured to:
acquire, as the use status, user identification information that enables identification of a user who has accessed information provided by the each of the plurality of functions among the plurality of users; and
execute the predetermined processing based on the user identification information for the each of the plurality of functions.

6. The information sharing system according to claim 1, wherein the at least one processor is configured to execute, as the predetermined processing, information display processing for displaying a piece of information of which use by each of the plurality of users satisfies a second criterion among a plurality of pieces of information provided by the each of the plurality of functions.

7. The information sharing system according to claim 1, wherein the at least one processor is configured to execute, as the predetermined processing, authority change processing for changing authority relating to a piece of information of which use by each of the plurality of users satisfies a third criterion among a plurality of pieces of information provided by the each of the plurality of functions.

8. The information sharing system according to claim 1, wherein the at least one processor is configured to:
search information provided by the each of the plurality of functions based on a search condition input by each of the plurality of users; and
execute, as the predetermined processing, hit processing for causing information provided by a frequently used function among the plurality of functions to be easily hit in a search.

9. The information sharing system according to claim 1,
wherein each of the plurality of functions is provided to each of the plurality of users through use of an API relating to the each of the plurality of functions, and
wherein the at least one processor is configured to acquire the use status of the each of the plurality of functions through use of the API for the each of the plurality of functions.

10. The information sharing system according to claim 1, wherein the at least one processor is configured to:
acquire, as the use status of the each of the plurality of functions, the number of times of access to the each of the plurality of functions; and
execute the predetermined processing based on the number of times of access to the each of the plurality of functions.

11. The information sharing system according to claim 1, wherein the at least one processor is configured to:
acquire, as the use status of the each of the plurality of functions, a display time period during which a screen relating to the each of the plurality of functions is being displayed; and
execute the predetermined processing based on the display time period of the each of the plurality of functions.

12. The information sharing system according to claim 1,
wherein each of the plurality of functions is added by any one of the plurality of users, and
wherein the at least one processor is configured to:
acquire the use status of the each of the plurality of functions added by the any one of the plurality of users; and
execute the predetermined processing based on the use status of the each of the plurality of functions added by the any one of the plurality of users.

13. A processing execution method, comprising:
acquiring a use status of use by each of a plurality of users for each of a plurality of functions relating to an information sharing service for sharing information; and
executing, for each of the plurality of functions, predetermined processing relating to the each of the plurality of functions based on the use status of the each of the plurality of functions.

14. A non-transitory information storage medium having stored thereon a program for causing a computer to:
acquire a use status of use by each of a plurality of users for each of a plurality of functions relating to an information sharing service for sharing information; and
execute, for each of the plurality of functions, predetermined processing relating to the each of the plurality of functions based on the use status of the each of the plurality of functions.
